(19) United States
(12) Patent Application Publication
(10) Pub. No.: US 2026/0031398 A1
(43) Pub. Date: Jan. 29, 2026

(54) SODIUM-ION BATTERY ELECTROLYTE AND SODIUM-ION BATTERY

(71) Applicant: SHENZHEN CAPCHEM TECHNOLOGY CO., LTD., Shenzhen (CN)

(72) Inventors: Zhongbo Liu, Shenzhen (CN); Yang Liu, Shenzhen (CN); Taiyuan Yang, Shenzhen (CN); Xiaohu Ao, Shenzhen (CN); Zhongtian Zheng, Shenzhen (CN)

(21) Appl. No.: 19/344,561

(22) Filed: Sep. 30, 2025

Related U.S. Application Data
(63) Continuation of application No. PCT/CN2024/070241, filed on Jan. 3, 2024.

(30) Foreign Application Priority Data
Mar. 31, 2023 (CN) 202310338683.0

(51) Int. Cl. H01M 10/0567; H01M 10/054; H01M 10/0568; H01M 10/0569; H01M 10/42

(52) U.S. Cl. CPC H01M 10/0567; H01M 10/054; H01M 10/0568; H01M 10/0569; H01M 10/4235; H01M 2300/004

(57) ABSTRACT

A sodium-ion battery electrolyte is disclosed, including a sodium salt, a non-aqueous organic solvent and an additive. The additive includes fluoroethylene carbonate, 1,3-propane sultone and 1,3-propene sultone, the sodium salt includes a primary sodium salt and sodium difluorophosphate. The sodium-ion battery electrolyte satisfies the following conditions: 0.3≤(a+b+c)*100/d≤7, and 1≤a≤5, 0.5≤b≤2, 1≤c≤3, 100≤d≤1000, where a represents a mass percentage of fluoroethylene carbonate in the sodium-ion battery electrolyte, in %; b represents a mass percentage of 1,3-propane sultone in the sodium-ion battery electrolyte, in %; c represents a mass percentage of 1,3-propene sultone in the sodium-ion battery electrolyte, in %; d represents a mass content of sodium difluorophosphate in the sodium-ion battery electrolyte, in ppm. Also disclosed is a sodium-ion battery including the sodium-ion battery electrolyte described above. The electrolyte can effectively improve high-temperature performance, reduce impedance, and mitigate adverse effects of the passivation film on the low-temperature performance and rate capability.

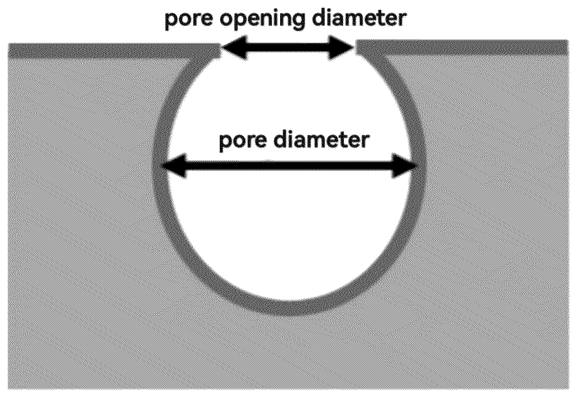

### CROSS-REFERENCE TO RELATED APPLICATIONS

The present application is a continuation application of PCT application No. PCT/CN2024/070241 filed on Jan. 3, 2024, which claims the benefit of Chinese Patent Application No. 202310338683.0 filed on Mar. 31, 2023. The contents of all of the aforementioned applications are incorporated by reference herein in their entirety.

### TECHNICAL FIELD

The present disclosure belongs to the technical field of secondary batteries, and particularly relates to a sodium-ion battery electrolyte and a sodium-ion battery.

### BACKGROUND

The principle and structure of sodium-ion batteries are similar to those of lithium-ion batteries. Compared to lithium-ion batteries, resources for sodium ion batteries are more abundant, at a lower cost and smaller price fluctuations, as well as a larger temperature range and higher safety performance, making them promising alternatives. With the continuous advancement of sodium-ion battery technology, sodium-ion batteries will play an essential role in China's energy system, particularly with strong growth potential in the field of energy storage. As a result, developing high-performance, low-cost sodium-ion batteries is a key factor in whether the technology can be industrialized.

Some additives, such as fluoroethylene carbonate and 1,3-propane sultone, are commonly added to existing electrolytes of sodium-ion batteries to improve cycle performance of the batteries. These conventional additives are primarily film-forming additives, whose working mechanism involves decomposition on the surface of the negative electrode to form a passivation film that protects the negative electrode material and the electrolyte. However, the formation of the passivation film may also increase the impedance of the batteries to some extent. In particular, some existing additives compete with each other during film formation, which may cause some variations in the film-forming behavior while exerting their respective effects, This competition may result in adverse outcomes such as reduced film strength and increased film thickness. These issues can further lead to insufficient high-temperature performance of the batteries and an increase in impedance, which in turn deteriorates the low-temperature performance and rate capability of the batteries.

### SUMMARY OF THE INVENTION

In order to address the issues of insufficient high-temperature performance and high impedance in existing sodium-ion batteries, the present disclosure provides a sodium-ion battery electrolyte and a sodium-ion battery.

The technical solution adopted by the present disclosure to solve the above technical problems is as follows:

In one aspect, the present disclosure provides a sodium-ion battery electrolyte, including a sodium salt, a non-aqueous organic solvent and an additive. The additive includes fluoroethylene carbonate, 1,3-propane sultone and 1,3-propene sultone, the sodium salt includes a primary sodium salt and sodium difluorophosphate;
the sodium-ion battery electrolyte satisfies the following conditions:

$$0.3 \leq ( a + b + c ) * 100 / d \leq 7 , and$$

$$1 \leq a \leq 5 , 0.5 \underline{<} b \leq 2 , 1 \leq c \leq 3 , 100 \leq d \leq 1 \; 000 ;$$

a represents a mass percentage of fluoroethylene carbonate in the sodium-ion battery electrolyte, in %;
b represents a mass percentage of 1,3-propane sultone in the sodium-ion battery electrolyte, in %;
c represents a mass percentage of 1,3-propene sultone in the sodium-ion battery electrolyte, in %; and
d represents a mass content of sodium difluorophosphate in the sodium-ion battery electrolyte, in ppm.

Optionally, the sodium-ion battery electrolyte satisfies the following conditions:

$$0.6 \leq ( a + b + c ) * 100 / d \leq 5.7 .$$

Optionally, the mass percentage (a) of fluoroethylene carbonate in the sodium-ion battery electrolyte is 2%-4%.

Optionally, the mass percentage (b) of 1,3-propane sultone in the sodium-ion battery electrolyte is 1%-2%.

Optionally, the mass percentage (c) of 1,3-propene sultone in the sodium-ion battery electrolyte is 1.5%-20.5%.

Optionally, the mass content (d) of sodium difluorophosphate in the sodium-ion battery electrolyte is 150-800 ppm.

Optionally, the primary sodium salt includes at least one selected from the group consisting of sodium perchlorate, sodium tetrafluoroborate, sodium hexafluorophosphate, sodium trifluoroacetate, sodium tetraphenylborate, sodium trifluoromethanesulfonate, sodium bis(fluorosulfonyl)imide and sodium bis(trifluoromethanesulfonyl)imide.

Preferably, a mass percentage of the primary sodium salt is 8%-14% based on a total mass of the sodium-ion battery electrolyte of 100%.

Optionally, the additive further includes at least one selected from the group consisting of ethylene sulfate, 1,4-butane sultone, and difluoroethylene carbonate; and
a mass percentage of the additive is 2.5%-10% based on the total mass of the sodium-ion battery electrolyte of 100%.

Optionally, the non-aqueous organic solvent includes at least one selected from the group consisting of carbonate esters, carboxylic esters, and ethers.

Optionally, the carbonate esters include cyclic or linear carbonate esters having 3-5 carbon atoms, the cyclic carbonate esters include at least one selected from the group consisting of ethylene carbonate, vinylene carbonate, vinyl ethylene carbonate, propylene carbonate, γ-butyrolactone, and butylene carbonate; the linear carbonate esters include at least one selected from the group consisting of dimethyl carbonate, ethyl methyl carbonate, diethyl carbonate and dipropyl carbonate;
the carboxylic esters include carboxylic esters having 2-6 carbon atoms, the carboxylic esters include at least one selected from the group consisting of methyl acetate, ethyl acetate, propyl acetate, butyl acetate, and propyl propionate;
the ethers include cyclic or linear ethers having 4-10 carbon atoms, the cyclic ethers include at least one selected from the group consisting of 1,3-dioxolane, 1,4-dioxane, tetrahydrofuran, 2-methyltetrahydrofuran and 2-(trifluoromethyl)tetrahydrofuran; the linear ethers include at least one selected from the group consisting of dimethoxymethane, 1,2-dimethoxyethane and diethylene glycol dimethyl ether; and
a mass percentage of the non-aqueous organic solvent is 70%-92% based on the total mass of the electrolyte of 100%.

In another aspect, the present disclosure provides a sodium-ion battery, including a positive electrode, a negative electrode, and the sodium-ion battery electrolyte as described above.

Optionally, the negative electrode includes a negative electrode material layer, a ratio E of pore diameter to pore opening diameter of the negative electrode material layer is 4-12.

Optionally, the ratio E of pore diameter to pore opening diameter of the negative electrode material layer is 5-10.

Optionally, the pore diameter of the negative electrode material layer is 0.5-5 nm, and/or, the pore opening diameter of the negative electrode material layer is 0.1-2 nm.

According to the sodium-ion battery electrolyte provided by the present disclosure, fluoroethylene carbonate, 1,3-propane sultone, and 1,3-propene sultone are used as additives. Fluoroethylene carbonate, 1,3-propane sultone, and 1,3-propene sultone jointly participate in the formation of a passivation film on the surface of the negative electrode. Meanwhile, a small amount of sodium difluorophosphate is added as part of the sodium salt. The inventors have found through research that sodium difluorophosphate plays a significant regulatory role in the film-forming behavior of fluoroethylene carbonate, 1,3-propane sultone, and 1,3-propene sultone on the negative electrode. In particular, when the mass percentage (a) of fluoroethylene carbonate, the mass percentage (b) of 1,3-propane sultone, the mass percentage (c) of 1,3-propene sultone, and the mass content (d) of sodium difluorophosphate in the sodium-ion battery electrolyte satisfy the following conditions: 0.3≤(a+b+c)*100/d 7, and 1≤a≤5, 0.5≤b≤2, 1≤c≤3, 100≤d≤1000, fluoroethylene carbonate, 1,3-propane sultone, 1,3-propene sultone, and sodium difluorophosphate jointly participate in the film-forming process. The resulting passivation film exhibits improved high-temperature stability, reduced thickness, and enhanced ionic conductivity, which can effectively improve the high-temperature storage performance and high-temperature cycle performance of the sodium-ion battery, while significantly reducing the battery impedance and mitigating adverse effects of the resulting passivation film on the low-temperature performance and rate capability of the battery.

### BRIEF DESCRIPTION OF THE DRAWINGS

The sole FIGURE is a schematic diagram of the pore diameter and the pore opening diameter of the negative electrode material layer.

### DETAILED DESCRIPTIONS OF THE EMBODIMENTS

In order to make the technical problems to be solved, technical solutions and beneficial effects of the present disclosure more clear, the present disclosure will be further explained in detail below with reference to the embodiments. It should be understood that the specific embodiments described here are intended only to illustrate the present disclosure and are not intended to limit it in any way.

Fluoroethylene carbonate, 1,3-propane sultone, and 1,3-propene sultone are film-forming additives used to decompose on the surface of the negative electrode of a sodium-ion battery to form a passivation film, thereby improving the high-temperature performance of the battery. However, the inventors have found through research that when the above three additives are used together in the same electrolyte, their effects interfere with one another. All the above three additives tend to increase the battery impedance due to the film-forming behavior, which in turn deteriorating the low-temperature performance and rate capability of the battery.

In order to address the above problems, the inventors conducted further research and provided a sodium-ion battery electrolyte, which includes a sodium salt, a non-aqueous organic solvent and an additive. The additive includes fluoroethylene carbonate, 1,3-propane sultone and 1,3-propene sultone, the sodium salt includes a primary sodium salt and sodium difluorophosphate;
the sodium-ion battery electrolyte satisfies the following conditions:

$$0.3 \leq ( a + b + c ) * 100 / d \leq 7 , and$$

$$1 \leq a \leq 5 , 0.5 \underline{<} b \leq 2 , 1 \leq c \leq 3 , 100 \leq d \leq 1 \; 000 ;$$

a represents the mass percentage of fluoroethylene carbonate in the sodium-ion battery electrolyte, in %;
b represents the mass percentage of 1,3-propane sultone in the sodium-ion battery electrolyte, in %;
c represents the mass percentage of 1,3-propene sultone in the sodium-ion battery electrolyte, in %; and
d represents the mass content of sodium difluorophosphate in the sodium-ion battery electrolyte, in ppm.

The inventors found that sodium difluorophosphate plays a significant regulatory role in the film-forming behavior of fluoroethylene carbonate, 1,3-propane sultone, and 1,3-propene sultone on the surface of the negative electrode. In particular, when the mass percentage (a) of fluoroethylene carbonate, the mass percentage (b) of 1,3-propane sultone, the mass percentage (c) of 1,3-propene sultone, and the mass content (d) of sodium difluorophosphate in the sodium-ion battery electrolyte satisfy the following conditions: 0.3≤(a+b+c)*100/d≤7, and 1≤a≤5, 0.5≤b≤2, 1≤c≤3, 100≤d≤1000, fluoroethylene carbonate, 1,3-propane sultone, 1,3-propene sultone, and sodium difluorophosphate jointly participate in the film-forming process. The resulting passivation film exhibits improved high-temperature stability, reduced thickness, and enhanced ionic conductivity, which can effectively improve the high-temperature storage and high-temperature cycle performance of the sodium-ion battery, while significantly reducing the battery impedance and mitigating adverse effects of the resulting passivation film on the low-temperature performance and rate capability of the battery.

It should be noted that the amounts of the above additives and sodium difluorophosphate must fall within the specified usage ranges and satisfy the relational expression described above; otherwise, battery performance may be adversely affected.

In a preferred embodiment, the sodium-ion battery electrolyte satisfies the following conditions:

$$0.6 \leq ( a + b + c ) * 100 / d \leq 5.7 .$$

By further limiting the mass percentage (a) of fluoroethylene carbonate, the mass percentage (b) of 1,3-propane sultone, the mass percentage (c) of 1,3-propene sultone, and the mass content (d) of sodium difluorophosphate in the sodium-ion battery electrolyte to meet the above conditions, the battery's high-temperature storage performance, cycle performance and gas suppression effect can be improved. This achieves a synergistic effect, thereby improving the high-temperature performance and lowering impedance of the battery.

In a specific embodiment, the mass percentage (a) of fluoroethylene carbonate in the sodium-ion battery electrolyte can be 1%, 1.2%, 1.4%, 1.7%, 1.9%, 2.1%, 2.2%, 2.4%, 2.7%, 2.9%, 3%, 3.2%, 3.5%, 3.8%, 4%, 4.5%, or 5%.

In a preferred embodiment, the mass percentage (a) of fluoroethylene carbonate in the sodium-ion battery electrolyte is 2%-4%.

Fluoroethylene carbonate can effectively improve the film-forming behavior on the negative electrode and improve the stability of the battery in cycle. When the content of fluoroethylene carbonate is too low, it cannot effectively participate in the film-forming process, resulting in poor film quality, poor stability between the positive and negative electrode interfaces, intensified side reactions, rapid capacity decay and poor cycle performance. When the content of fluoroethylene carbonate is too high, the improvement in film quality for the sodium-ion battery becomes insignificant. Instead, it affects the content of decomposition products of 1,3-propane sultone and 1,3-propene sultone in the passivation film on the negative electrode, thereby hindering the improvement of the film-forming quality of the sodium-ion battery.

In a specific embodiment, the mass percentage (b) of 1,3-propane sultone in the sodium-ion battery electrolyte can be 0.5%, 0.55%, 0.6%, 0.65%, 0.7%, 0.75%, 0.8%, 0.85%, 0.9%, 0.95%, 1%, 1.1%, 1.15%, 1.2%, 1.25%, 1.3%, 1.35%, 1.4%, 1.45%, 1.5%, 1.55%, 1.6%, 1.65%, 1.7%, 1.75%, 1.8%, 1.85%, 1.9%, 1.95%, or 2%.

In a preferred embodiment, the mass percentage (b) of 1,3-propane sultone in the sodium-ion battery electrolyte is 1%-2%.

1,3-propane sultone can decompose on the negative electrode to form a film, which can effectively suppress the side reactions of electrolyte on the surface of the negative electrode, thereby achieving the effect of inhibiting gas generation of the battery, especially under high-temperature cycle and high-temperature storage conditions, which can effectively improve the high-temperature storage performance. When the content of 1,3-propane sultone in the sodium-ion battery electrolyte is too low, the improvement in the quality of the passivation film on the negative electrode is insignificant. When the content of 1,3-propane sultone in the sodium-ion battery electrolyte is too high, gas generation cannot be effectively inhibited, and the high-temperature storage performance and cycle performance of the sodium-ion battery are deteriorated.

In a specific embodiment, the mass percentage (c) of 1,3-propene sultone in the sodium-ion battery electrolyte can be 1%, 1.2%, 1.4%, 1.7%, 1.9%, 2.1%, 2.2%, 2.4%, 2.7%, 2.9%, or 3%.

In a preferred embodiment, the mass percentage (c) of 1,3-propene sultone in the sodium-ion battery electrolyte is 1.5%-2.5%.

1,3-propene sultone can form a stable interfacial film on the surface of the electrode, inhibit decomposition of solvent molecules at the negative electrode, and effectively improve the cycle and high-temperature storage performance of the battery. When the content of 1,3-propene sultone in the sodium-ion battery electrolyte is too low, the improvement in the quality of the passivation film on the negative electrode is insignificant. When the content of 1,3-propene sultone added in the sodium-ion battery electrolyte is too high, the film formed on the surface of the negative electrode is of poor quality and cannot effectively improve the cycle performance of the sodium-ion battery.

In a specific embodiment, the mass content (d) of sodium difluorophosphate in the sodium-ion battery electrolyte can be 100 ppm, 150 ppm, 200 ppm, 250 ppm, 300 ppm, 350 ppm, 400 ppm, 450 ppm, 500 ppm, 600 ppm, 700 ppm, 800 ppm, 900 ppm, or 1000 ppm.

In a preferred embodiment, the mass content (d) of sodium difluorophosphate in the sodium-ion battery electrolyte is 150-800 ppm.

By using a sodium salt containing a specific mass content of sodium difluorophosphate, the side effect of increased impedance caused by the additive can be effectively mitigated through participation in the film-forming process, without deteriorating other performance aspects of the battery, thereby improving the stability of the electrolyte. When the content of sodium difluorophosphate in the sodium-ion battery electrolyte is too low, significant interference occurs among fluoroethylene carbonate, 1,3-propane sultone, and 1,3-propene sultone during film-forming process, resulting in a thicker passivation film on the surface of the negative electrode and a reduction in its high-temperature stability, which adversely affects the high-temperature performance of the battery. When the content of sodium difluorophosphate in the sodium-ion battery electrolyte is too high, side reactions are likely to be triggered during cycling of the sodium-ion battery electrolyte, thereby compromising the stability of the electrolyte.

In some embodiments, the primary sodium salt includes at least one of sodium perchlorate, sodium tetrafluoroborate, sodium hexafluorophosphate, sodium trifluoroacetate, sodium tetraphenylborate, sodium trifluoromethanesulfonate, sodium bis(fluorosulfonyl)imide and sodium bis(trifluoromethanesulfonyl)imide.

In some embodiments, the mass percentage of the primary sodium salt is 8%-14% based on the total mass of the sodium-ion battery electrolyte of 100%.

When the mass percentage of the primary sodium salt in the sodium-ion battery electrolyte falls within the above range, the conductivity and electrochemical stability of the sodium-ion battery electrolyte can be improved.

In some embodiments, the additive further includes at least one of ethylene sulfate, 1,4-butane sultone, and difluoroethylene carbonate.

The mass percentage of the additive is 2.5%-10% based on the total mass of the sodium-ion battery electrolyte of 100%.

In some embodiments, the non-aqueous organic solvent includes at least one of carbonate esters, carboxylic esters, and ethers.

Preferably, the carbonate esters include cyclic or linear carbonate esters having 3-5 carbon atoms, the cyclic carbonate esters include at least one of ethylene carbonate, vinylene carbonate, vinyl ethylene carbonate, propylene carbonate, γ-butyrolactone, and butylene carbonate; the linear carbonate esters include at least one of dimethyl carbonate, ethyl methyl carbonate, diethyl carbonate and dipropyl carbonate.

The carboxylic esters include carboxylic esters having 2-6 carbon atoms, the carboxylic esters include at least one of methyl acetate, ethyl acetate, propyl acetate, butyl acetate, and propyl propionate.

The ethers include cyclic or linear ethers having 4-10 carbon atoms, the cyclic ethers include at least one of 1,3-dioxolane, 1,4-dioxane, tetrahydrofuran, 2-methyltetrahydrofuran and 2-(trifluoromethyl)tetrahydrofuran; the linear ethers include at least one of dimethoxymethane, 1,2-dimethoxyethane and diethylene glycol dimethyl ether.

The mass percentage of the non-aqueous organic solvent is 70%-92% based on the total mass of the electrolyte of 100%.

Another embodiment of the present disclosure provides a sodium-ion battery, which includes a positive electrode, a negative electrode and the sodium-ion battery electrolyte as described above.

In some embodiments, the positive electrode includes a positive electrode material layer, which includes a positive electrode active material. The positive electrode active material includes at least one of sodium-containing layered oxides, sodium-containing polyanionic compounds, and sodium-containing Prussian blue compounds.

The sodium-containing layered oxides include layered transition metal oxides, which include a compound represented by Formula I:

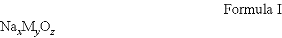

where 0<x≤1, 0<y≤1 and 1<z≤2, and M is selected from at least one of Cr, Fe, Co, Ni, Cu, Mn, Sn, Mo, Sb and V;
the Prussian blue compounds include a compound represented by Formula II:

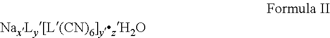

where 0<x′≤2, 0<y′≤1, 0<z′≤20, L and L′ are independently selected from at least one of Cr, Fe, Co, Ni, Cu, Mn, Sn, Mo, Sb and V;
the polyanionic compounds include at least one of phosphate compounds and sulfate compounds;
the phosphate compounds include at least one compound represented by Formula III or Formula IV:

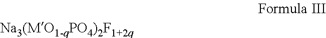

where 0≤q≤1, and M′ is selected from at least one of Al, V, Ge, Fe and Ga; Na₂EPO₄F Formula IV
where E is selected from at least one of Fe and Mn;
the sulfate compounds include at least one compound represented by Formula V;

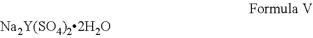

where Y is selected from at least one of Cr, Fe, Co, Ni, Cu, Mn, Sn, Mo, Sb and V.

In some preferred embodiments, the layered transition metal oxides are selected from NaₓMO₂ (0<x≤1), and M is selected from at least one of V, Cr, Mn, Fe, Co, Ni, and Cu.

The Prussian blue compounds include at least one of the compounds Naₓ·Mn[Fe(CN)₆]_{y}·z′H₂O and Naₓ·Fe[Fe(CN)₆]_{y}·z′H₂O, where 0<x′≤2, 0<y′≤1 and 0<z′≤20.

The phosphate compounds include at least one of Na₃(VPO₄)₂F₃, Na₃(VOPO₄)₂F, Na₂FePO₄F, and Na₂MnPO₄F.

In some embodiments, the negative electrode includes a negative electrode material layer, which includes a negative electrode active material. The negative electrode active material includes at least one of soft carbon, hard carbon, carbon nanotubes, expanded graphite, and graphene.

In some embodiments, a ratio E of pore diameter to pore opening diameter of the negative electrode material layer is 4-12.

Based on the sodium-ion battery system provided by the present invention, the inventors have further found that, when fluoroethylene carbonate, 1,3-propane sultone, 1,3-propene sultone, and sodium difluorophosphate are simultaneously used as film-forming additives in the sodium-ion battery, the pore morphology of the negative electrode material layer has a significant influence on the film uniformity and densification. Specifically, when the ratio E of pore diameter to pore opening diameter of the negative electrode material layer satisfies 5-10, the ionic conduction efficiency of the passivation film formed on the surface of the negative electrode can be further enhanced, thereby effectively improving the low-temperature discharge performance and the rate performance of the sodium-ion battery. It is presumed that the negative electrode material layer, in which the ratio of pore diameter to pore opening diameter satisfies the condition, can regulate the desolvation process to some extent, allowing most sodium ions to remove solvent molecules before entering micropores. As a result, fluoroethylene carbonate, 1,3-propane sultone, 1,3-propene sultone, and sodium difluorophosphate mainly form the passivation film outside the pores when participating in the formation of the passivation film, which can effectively prevent the passivation film from being formed inside the pores, avoid blockage of the pores caused by the passivation film itself, helping ensure that the pores of the negative electrode material layer themselves function in the deintercalation and conduction of sodium ions, and ensure that the battery maintains favorable rate performance while still retaining favorable low-temperature cycle performance at low temperatures.

As shown in the sole FIGURE, in the present disclosure, the term “pore diameter of the negative electrode material layer” refers to the diameter of the internal cavities of the pores in the material, which can be measured by a gas adsorption method. The gas adsorption method is based on the adsorption interaction of gas molecules (adsorbates) on the surface of the material to be measured (adsorbent), caused by van der Waals forces. By measuring the adsorption isotherm of the sample and adopting the method of equivalent substitution, the specific surface area and the distribution characteristics of the pore diameter of the material can be calculated. This method is applicable to testing various pore diameter ranges, including micropores, mesopores, and macropores. In specific applications, the gas adsorption method can measure the amount of condensed gas of the sample under different pressure conditions, plot adsorption and desorption isotherms, and further obtain the pore volume and pore diameter distribution curves by theoretical methods.

In the present disclosure, the term “pore opening diameter of the negative electrode material layer” specifically refers to the diameter of the openings on the external surface of the porous material that are connected with the internal pores, which is measured by a microscope and image processing technology. The negative electrode sheet is placed under the microscope, an image is captured through an imaging device, and the image is analyzed using computer image processing software to obtain the pore opening diameter distribution curve. The specific steps are as follows: placing the sodium-ion battery electrode sheet to be tested under the microscope, magnifying it to an appropriate multiple through the microscope, connecting the imaging device with a computer, capturing the images observed under the microscope into the computer, processing the captured images using computer image processing software, extracting the contours of the pores, performing scanning measurement, and obtaining the pore opening diameter distribution curve according to the measurement results.

In preferred embodiments, the ratio E of pore diameter to pore opening diameter of the negative electrode material layer is 5-10.

In some embodiments, the pore diameter of the negative electrode material layer is 0.5-5 nm, and/or, the pore opening diameter of the negative electrode material layer is 0.1-2 nm.

When the pore diameter of the negative electrode material layer and the pore opening diameter of the negative electrode material layer satisfy the above conditions, it helps to avoid the adverse effect of fluoroethylene carbonate, 1,3-propane sultone, 1,3-propene sultone, and sodium difluorophosphate on the efficiency of sodium-ion deintercalation and conduction at the negative electrode during the film-forming process, thereby enhancing the performance of the sodium-ion battery at low temperatures and at high charge/discharge rates.

The present disclosure will be further described with reference to the following embodiments.

TABLE 1

| | Electrolyte | | | | | | | |
|---|---|---|---|---|---|---|---|---|
| | Mass | | | Mass | | | | |
| | percentage | Mass | Mass | content | Mass | | | |
| | (a) of | percentage | percentage | (d) of | content | | | |
| | fluoro- | (b) of | (c) of | sodium | of primary | | | |
| | ethylene | 1,3-propane | 1,3-propene | difluoro- | sodium | | | |
| | carbonate | sultone | sultone | phosphate | salt | Types of primary | Positive | (a + b + |
| Group | (%) | (%) | (%) | (ppm) | (%) | sodium salt | electrode active materials | c)*100/d |
| Embodiment 1 | 2 | 1 | 2 | 300 | 8 | NaPF₆ | Na_{1.2}Ni₂[Fe(CN)₆]_{0.5}•H₂O | 1.67 |
| Embodiment 2 | 5 | 2 | 2 | 701 | 8 | NaPF₆ | Na_{1.2}Ni₂[Fe(CN)₆]_{0.5}•H₂O | 1.28 |
| Embodiment 3 | 2.5 | 1.8 | 1.2 | 423 | 10 | NaPF₆ | Na_{1.2}Ni₂[Fe(CN)₆]_{0.5}•H₂O | 1.30 |
| Embodiment 4 | 1 | 0.8 | 2.8 | 787 | 9 | NaPF₆ | Na_{1.2}Ni₂[Fe(CN)₆]_{0.5}•H₂O | 0.58 |
| Embodiment 5 | 1.1 | 1.6 | 1.7 | 725 | 7 | NaPF₆ | Na_{1.2}Ni₂[Fe(CN)₆]_{0.5}•H₂O | 0.61 |
| Embodiment 6 | 1 | 0.5 | 1 | 803 | 8 | NaPF₆ | Na_{1.2}Ni₂[Fe(CN)₆]_{0.5}•H₂O | 0.31 |
| Embodiment 7 | 4 | 1 | 1.9 | 271 | 8 | NaPF₆ | Na_{1.2}Ni₂[Fe(CN)₆]_{0.5}•H₂O | 2.55 |
| Embodiment 8 | 2 | 0.5 | 2 | 437 | 8 | NaPF₆ | Na_{1.2}Ni₂[Fe(CN)₆]_{0.5}•H₂O | 1.03 |
| Embodiment 9 | 2.9 | 1.4 | 2.2 | 248 | 7 | NaPF₆ | Na_{1.2}Ni₂[Fe(CN)₆]_{0.5}•H₂O | 2.62 |
| Embodiment 10 | 2.6 | 0.7 | 2 | 610 | 8 | NaPF₆ | Na_{1.2}Ni₂[Fe(CN)₆]_{0.5}•H₂O | 0.87 |
| Embodiment 11 | 3.2 | 1.9 | 2.2 | 598 | 9 | NaPF₆ | Na_{1.2}Ni₂[Fe(CN)₆]_{0.5}•H₂O | 1.22 |
| Embodiment 12 | 1.7 | 2 | 1.3 | 487 | 7 | NaPF₆ | Na_{1.2}Ni₂[Fe(CN)₆]_{0.5}•H₂O | 1.03 |
| Embodiment 13 | 5 | 1.7 | 2.7 | 137 | 9 | NaPF₆ | Na_{1.2}Ni₂[Fe(CN)₆]_{0.5}•H₂O | 6.86 |
| Embodiment 14 | 2.8 | 0.9 | 1 | 429 | 8 | NaPF₆ | Na_{1.2}Ni₂[Fe(CN)₆]_{0.5}•H₂O | 1.10 |
| Embodiment 15 | 3.5 | 1.8 | 1.2 | 600 | 10 | NaPF₆ | Na_{1.2}Ni₂[Fe(CN)₆]_{0.5}•H₂O | 1.08 |
| Embodiment 16 | 4.9 | 1.3 | 2.9 | 990 | 7 | NaPF₆ | Na_{1.2}Ni₂[Fe(CN)₆]_{0.5}•H₂O | 0.92 |
| Embodiment 17 | 1.9 | 1.3 | 1.6 | 631 | 10 | NaPF₆ | Na_{1.2}Ni₂[Fe(CN)₆]_{0.5}•H₂O | 0.76 |
| Embodiment 18 | 3.3 | 0.8 | 3 | 272 | 9 | NaPF₆ | Na_{1.2}Ni₂[Fe(CN)₆]_{0.5}•H₂O | 2.61 |
| Embodiment 19 | 2.1 | 1.7 | 1.5 | 103 | 7 | NaPF₆ | Na_{1.2}Ni₂[Fe(CN)₆]_{0.5}•H₂O | 5.15 |
| Embodiment 21 | 2 | 1 | 2 | 300 | 8 | NaClO₄ | Na_{1.2}Ni₂[Fe(CN)₆]_{0.5}•H₂O | 1.67 |
| Embodiment 22 | 2 | 1 | 2 | 300 | 8 | NaBF₄ | Na_{1.2}Ni₂[Fe(CN)₆]_{0.5}•H₂O | 1.67 |
| Embodiment 23 | 2 | 1 | 2 | 300 | 8 | Na[(FSO₂)₂N] | Na_{1.2}Ni₂[Fe(CN)₆]_{0.5}•H₂O | 1.67 |
| Embodiment 24 | 2 | 1 | 2 | 300 | 8 | Na[(CF₃SO₂)₂N | Na_{1.2}Ni₂[Fe(CN)₆]_{0.5}•H₂O | 1.67 |
| Embodiment 25 | 2 | 1 | 2 | 300 | 8 | NaPF₆ | NaNi0.3Mn0.2Cu0.5O2 | 1.67 |
| Embodiment 26 | 2 | 1 | 2 | 300 | 8 | NaPF₆ | NaNi0.1Mn0.4Cu0.5O2 | 1.67 |
| Embodiment 27 | 2 | 1 | 2 | 300 | 8 | NaPF₆ | Na₃(VPO₄)₂F₃ | 1.67 |
| Embodiment 28 | 2 | 1 | 2 | 300 | 8 | NaPF₆ | Na3(VOPO4)2F | 1.67 |
| Comparative | 0.5 | 1.8 | 1 | 523 | 8 | NaPF₆ | Na_{1.2}Ni₂[Fe(CN)₆]_{0.5}•H₂O | 0.63 |
| example 1 | | | | | | | | |
| Comparative | 6 | 2 | 2.2 | 163 | 8 | NaPF₆ | Na_{1.2}Ni₂[Fe(CN)₆]_{0.5}•H₂O | 6.26 |
| example 2 | | | | | | | | |
| Comparative | 1.9 | 0.3 | 3 | 234 | 8 | NaPF₆ | Na_{1.2}Ni₂[Fe(CN)₆]_{0.5}•H₂O | 2.22 |
| example 3 | | | | | | | | |
| Comparative | 3.4 | 3 | 2.4 | 439 | 8 | NaPF₆ | Na_{1.2}Ni₂[Fe(CN)₆]_{0.5}•H₂O | 2.00 |
| example 4 | | | | | | | | |
| Comparative | 2.7 | 1 | 0.5 | 265 | 8 | NaPF₆ | Na_{1.2}Ni₂[Fe(CN)₆]_{0.5}•H₂O | 1.58 |
| example 5 | | | | | | | | |
| Comparative | 1.6 | 2.1 | 5 | 325 | 8 | NaPF₆ | Na_{1.2}Ni₂[Fe(CN)₆]_{0.5}•H₂O | 2.68 |
| example 6 | | | | | | | | |
| Comparative | 1.5 | 0.7 | 1.3 | 54 | 8 | NaPF₆ | Na_{1.2}Ni₂[Fe(CN)₆]_{0.5}•H₂O | 6.48 |
| example 7 | | | | | | | | |
| Comparative | 2.3 | 1.8 | 1.5 | 1350 | 8 | NaPF₆ | Na_{1.2}Ni₂[Fe(CN)₆]_{0.5}•H₂O | 0.41 |
| example 8 | | | | | | | | |
| Comparative | 2 | 1 | 2 | 0 | 8 | NaPF₆ | Na_{1.2}Ni₂[Fe(CN)₆]_{0.5}•H₂O | 62.50 |
| example 9 | | | | | | | | |
| Comparative | 5 | 2 | 3 | 103 | 7 | NaPF₆ | Na_{1.2}Ni₂[Fe(CN)₆]_{0.5}•H₂O | 9.71 |
| example 10 | | | | | | | | |
| Comparative | 4.8 | 1.6 | 2.8 | 121 | 8 | NaPF₆ | Na_{1.2}Ni₂[Fe(CN)₆]_{0.5}•H₂O | 7.60 |
| example 11 | | | | | | | | |
| Comparative | 4.3 | 1.8 | 2.5 | 108 | 7 | NaPF₆ | Na_{1.2}Ni₂[Fe(CN)₆]_{0.5}•H₂O | 7.96 |
| example 12 | | | | | | | | |
| Comparative | 1 | 0.6 | 1.1 | 976 | 8 | NaPF₆ | Na_{1.2}Ni₂[Fe(CN)₆]_{0.5}•H₂O | 0.28 |
| example 13 | | | | | | | | |
| Comparative | 1.2 | 0.5 | 1 | 985 | 9 | NaPF₆ | Na_{1.2}Ni₂[Fe(CN)₆]_{0.5}•H₂O | 0.27 |
| example 14 | | | | | | | | |
| Comparative | 1 | 0.5 | 1.1 | 953 | 9 | NaPF₆ | Na_{1.2}Ni₂[Fe(CN)₆]_{0.5}•H₂O | 0.27 |
| example 15 | | | | | | | | |

### Embodiment 1

This embodiment is used to illustrate the sodium-ion battery and the preparation method thereof disclosed in the present disclosure, including the following steps.

### 1) Preparation of Sodium-Ion Battery Electrolyte

Ethylene carbonate (EC), propylene carbonate (PC), and diethyl carbonate (DEC) were mixed in a mass ratio of EC:PC:DEC=75:15:10. Based on the total mass of the sodium-ion battery electrolyte of 100%, additives and sodium salts were added in the mass ratio shown in Table 1.

### 2) Preparation of Positive Electrode Plate

The positive electrode active material Na_{1.2}Ni₂[Fe(CN)₆]_{0.5}·H₂O, conductive carbon black Super-P, and binder polyvinylidene fluoride (PVDF) was mixed in a mass ratio of 93:4:3, and then dispersed in N-methyl-2-pyrrolidone (NMP) to obtain a positive electrode slurry. An aluminum foil was used as a positive current collector, and the slurry was evenly coated on both sides of the aluminum foil. After being dried, calendered, and vacuum-dried, a positive electrode material layer was obtained. The positive electrode plate was then obtained by welding aluminum tabs with an ultrasonic welder.

### 3) Preparation of Negative Electrode Plate

Hard carbon, conductive carbon black Super-P, binder styrene-butadiene rubber (SBR), and carboxymethyl cellulose (CMC) were mixed in a mass ratio of 94:1:2.5:2.5 and dispersed in deionized water to obtain a negative electrode slurry. The slurry was coated on both sides of an aluminum foil. After being dried, calendered, and vacuum-dried, the negative electrode plate was obtained by welding nickel tabs with an ultrasonic welder.

The pore diameter and the pore opening diameter of the negative electrode material layer on the obtained negative electrode plate were tested, and the test results showed that the pore diameter of the negative electrode material layer was 2.4 nm, the pore opening diameter of the negative electrode material layer was 0.4 nm, and a ratio E of pore diameter to pore opening diameter of the negative electrode material layer was 6.

### 3.1 Pore Diameter Test Method: Gas Adsorption Method

### Specific Test Method:

\textcircled{1} Weigh the empty sample tube, and record the mass as m₀;
\textcircled{2} Take a certain amount of negative electrode plate, cut it into small strips until it can be loaded into the sample tube;
\textcircled{3} Load the strip-shaped electrode sheets into the bulb of the sample tube until the bulb is filled;
\textcircled{4} The sample tube filled with the sample is installed on the degassing station for degassing, cooled down, then weighed, and the mass of the sample tube with the sample is recorded as m₁;
\textcircled{5} The sample tube containing the electrode sheets is installed on the pore diameter analyzer, and the mass of the empty tube m₀ and the mass of the tube with the sample m₁ are entered to perform pore diameter distribution testing.

Note: The pore diameter analyzer used in step \textcircled{5} is a TriStar II 3020 pore diameter analyzer from Micromeritics, USA, and the calculation method employed is the BJH method.

The empty sample tube referred to in step \textcircled{1} is a bulb-type tube supplied with the TriStar II 3020 pore diameter analyzer from Micromeritics, USA. The inner diameter of the tube is 6.4 mm, 9.6 mm, or 12.7 mm, and the sample tube should be cleaned and dried before use.

The electrode sheets prepared in step \textcircled{2} are small strip-shaped electrode sheets with a length of 0.5-2 cm and a width of 3-5 mm.

In step \textcircled{3}, the electrode sheets should not be damaged during the sample loading process to avoid powder falling off. The bulb of the bulb-type sample tube may be filled, but attention should be paid to prevent the sample from exceeding the bulb portion or adhering to the tube wall.

In step \textcircled{4}, the degassing condition is degassing at 80-100° C. for 1-3 hours.

In step \textcircled{5}, the sample tube containing the electrode sheets is installed on the pore diameter analyzer. The relative pressure of the adsorption branch is set to p/p₀=0.05-0.995, the relative pressure of the desorption branch is set to p/p₀=0.995-0.1. The adsorption is set with 30-60 points, and the desorption is set with 20-40 measurement points. The report output formats are set as summary, BJH adsorption, and BJH desorption. The pore diameter distribution of the electrode sheets is calculated using the BJH method.

The calculation formula of the BJH method is as follows:

$$Pore volume ( Vp ) : Vp = \frac{1}{R T} \times \frac{d V}{d ( log P )} ;$$

$$Pore diameter ( Dp ) : Dp = \frac{4 Vp}{π} ;$$

where R is the ideal gas constant, T is the experimental temperature, Vp is the pore volume, P is the relative pressure.

### 3.2 Pore Opening Diameter Test Method: Transmission Electron Microscopy (TEM)

### Specific Test Method:

\textcircled{1} Sample preparation: The electrode sheet is thinned by ion milling to prepare an ultrathin sample suitable for TEM observation, so that the electron beam can penetrate the sample.
\textcircled{2} Sample loading: The prepared sample is loaded onto the sample holder of the TEM, and it is ensured that the sample is stably fixed in place.
\textcircled{3} Microscope operation: Under a high-vacuum environment, the TEM is started and the accelerating voltage and current of the electron beam are adjusted to obtain the optimal image resolution.
\textcircled{4} Image acquisition: The sample is observed through the electron optical system of the TEM, and images of the pore opening diameter are acquired.
\textcircled{5} Image analysis: Image analysis software, such as DigitalMicrograph or ImageJ, is used to analyze the TEM images in order to measure the pore opening diameter.
\textcircled{6} Data processing: The measurement results are subjected to statistical analysis, the mathematical expectation value is taken to obtain the pore opening diameter.

### 4) Preparation of Battery Cell

A three-layer separator was placed between the positive electrode plate and the negative electrode plate. The N/P ratio between the positive and negative electrode plates is shown in Table 1. The sandwich structure formed by the positive electrode plate, negative electrode plate, and separator was then wound, flattened, and placed into an aluminum pouch. The assembly was vacuum-dried at 85° C. for 48 hours to obtain a battery cell ready for electrolyte injection.

### 5) Injection and Formation of Battery Cell

In a glove box with the dew point controlled below −40° C., the prepared electrolyte was injected into the battery cell. After vacuum sealing, the battery cell was left to stand for 24 hours, followed by a formation process.

### Embodiments 2-28

Embodiments 2-28 are used to illustrate the sodium-ion battery and the preparation method thereof disclosed in the present disclosure, including most of the steps in Embodiment 1, with the following differences.

The positive electrode active materials, additives, sodium salts, and their respective contents used are those corresponding to Embodiments 2-28 in Table 1.

### Comparative Examples 1-15

Comparative examples 1-15 are used to illustrate the sodium-ion battery and its preparation method disclosed in the present disclosure, including most of the steps in Embodiment 1, with the following differences.

The positive electrode active materials, additives, sodium salts, and their respective contents used are those corresponding to Comparative examples 1-15 in Table 1.

### Performance Test

The following performance tests were conducted on the sodium-ion battery prepared in Embodiments 1-28 and Comparative examples 1-15.

### 1. Impedance Performance Test

The discharge DCIR of the sodium-ion battery prepared in the Embodiments and Comparative examples was measured after formation.

### 2. Cycle Performance Test at 25° C.

The formed sodium-ion batteries were placed at room temperature of 25° C. They were charged to 3.9V at a constant current of 0.7 C, then charged at a constant voltage of 3.9V, with a cut-off current of 0.05 C, then discharged to 1.5V at a constant current of 1 C. This process was repeated for 400 cycles.

Capacity retention after 400 cycles at 25° C. is calculated by the following formula:

$$Capacity retention after 400 cycles at 25 ° C . ( \% ) = Discharge capacity at the 400 th cycle / Discharge capacity at the 1 st cycle \times 100 \% .$$

### 3. High-Temperature Cycle Performance Test

The formed sodium-ion batteries were placed under a high-temperature condition of 45° C. They were charged to 3.9V at a constant current of 0.7 C, then charged at a constant voltage of 3.9V, with a cut-off current of 0.05 C, followed by discharge to 1.5V at a constant current of IC. This process was repeated for 200 and 400 cycles.

Gas generation rate after 200 cycles at 45° C. is calculated by the following formula:

$$Gas generation rate after 200 cycles at 45 ° C . ( \% ) = ( Battery volume at the 200 th cycle - Battery volume at the 1 st cycle ) \text{} / Battery volume at the 1 st cycle \times 100 \% .$$

Capacity retention rate after 400 cycles at 45° C. is calculated by the following formula:

$$Capacity retention rate after 400 cycles at 45 ° C . ( \% ) = Discharge capacity at the 400 th cycle / Discharge capacity at the 1 st cycle \times 100 \% .$$

### 4. High-Temperature Storage Performance Test

The sodium-ion battery after formation was charged to 3.9V at a constant current of 0.7 C, then charged at a constant current and constant voltage until the current decreased to 0.05 C, and subsequently discharged to 1.5V at a constant current of 1 C. The initial discharge capacity C₀ of the battery was measured. The battery was then stored in an oven at a constant temperature of 60° C. After 30 days of storage, it was discharged to 1.5V at a standard discharge rate. And the recovery capacity C₁ and retention capacity C₂ after 30 days of storage were measured.

$$Capacity recovery rate ( \% ) = Recovery capacity {C}_{1} / Initial discharge capacity {C}_{0} \times 100 \% ;$$

$$Capacity recovery rate ( \% ) = Recovery capacity {C}_{2} / Initial discharge capacity {C}_{0} \times 100 \% .$$

### 5. Low-Temperature Discharge Performance Test

The sodium-ion battery after formation was charged at room temperature with a constant current of 0.7 C to 3.9V, followed by constant current and voltage charging until the current decreased to 0.05 C. The battery was then discharged with a constant current of 1 C to 1.5V, and the initial discharge capacity of the battery was measured. The sodium-ion battery was subsequently charged at room temperature with a constant current of 0.7 C to 3.9V, followed by constant current and voltage charging until the current decreased to 0.05 C. The battery was then transferred to −20° C. and stood for 4 hours, after which it was discharged at 20° C. with a constant current of 1 C to 1.5V, the discharge capacity of the battery at −20° C. was measured.

$$- 20 ° C . low - temperature discharge capacity retention ( \% ) = discharge capacity at - 20 ° C . / initial discharge capacity \times 100 \% .$$

### 6. Rate Performance Test

The sodium-ion battery after formation was charged at room temperature with a constant current of 0.7 C to 3.9V, followed by constant current and voltage charging until the current decreased to 0.05 C. The battery was then discharged with a constant current of 1 C to 1.5V, and the initial discharge capacity of the battery was measured. The sodium-ion battery was subsequently charged at room temperature with a constant current of 0.7 C to 3.9V, followed by constant current and voltage charging until the current decreased to 0.05 C. The battery was then discharged with a constant current of 30 C to 1.5V, the discharge capacity of the battery at 30 C was measured.

$$25 ° C . 30 C discharge capacity retention ( \% ) = discharge capacity at 30 C / initial discharge capacity \times 100 \% .$$

(1) The test results of Embodiments 1-19 and Comparative examples 1-15 are shown in Table 2.

TABLE 2

| | | | | | Capacity | Capacity | | |
|---|---|---|---|---|---|---|---|---|
| | | Gas | Capacity | Capacity | retention | recovery | −20° C. low- | |
| | | generation | retention | retention | rate after | rate after | temperature | 25° C. 30 C |
| | | rate after | rate after | rate after | storage | storage | discharge | discharge |
| | Discharge | 200 cycles | 400 cycles | 400 cycles | at 60° C. | at 60° C. | capacity | capacity |
| | DCIR | at 45° C. | at 25° C. | at 45° C. | for 30 days | for 30 days | retention | retention |
| Group | (mΩ) | (%) | (%) | (%) | (%) | (%) | (%) | (%) |
| Embodiment 1 | 60 | 26 | 91.1 | 90 | 91.6 | 93.9 | 92.1 | 82.4 |
| Embodiment 2 | 75 | 32 | 90.4 | 89.2 | 90.3 | 92.6 | 91.9 | 81.6 |
| Embodiment 3 | 62 | 29 | 90.5 | 89.3 | 90.1 | 92.3 | 91.3 | 81.3 |
| Embodiment 4 | 54 | 30.4 | 90.1 | 89 | 89.9 | 92.4 | 91.1 | 81.2 |
| Embodiment 5 | 58 | 31.5 | 89.9 | 88.4 | 90.4 | 92.9 | 90.8 | 81 |
| Embodiment 6 | 56 | 29.9 | 90.4 | 89.1 | 90.1 | 92 | 91.5 | 81.4 |
| Embodiment 7 | 71 | 27 | 90.9 | 89.9 | 91.3 | 93.1 | 91.6 | 81.7 |
| Embodiment 8 | 62 | 28.9 | 90.2 | 89 | 90.4 | 92.3 | 91.2 | 81.1 |
| Embodiment 9 | 67 | 27.5 | 91.8 | 90.4 | 91.9 | 94 | 92.6 | 82.5 |
| Embodiment 10 | 66.4 | 30.2 | 90.5 | 89.4 | 90.6 | 92.9 | 91.4 | 81.4 |
| Embodiment 11 | 69.7 | 31.2 | 90.2 | 89 | 90.2 | 92.4 | 91.7 | 81.8 |
| Embodiment 12 | 63.2 | 32.5 | 89.8 | 88.8 | 89.8 | 91.8 | 91.1 | 80.9 |
| Embodiment 13 | 76.4 | 32.3 | 89.5 | 88.4 | 89.4 | 91.5 | 90.7 | 80.8 |
| Embodiment 14 | 65.3 | 33.5 | 90.2 | 89.1 | 90.5 | 92.9 | 91.2 | 81.4 |
| Embodiment 15 | 69.8 | 33.1 | 89.3 | 88.2 | 89.3 | 91.5 | 90.6 | 80.5 |
| Embodiment 16 | 75.2 | 32.5 | 89.9 | 88.7 | 88.9 | 91.9 | 90.1 | 80.7 |
| Embodiment 17 | 66.3 | 33.6 | 89.1 | 87.9 | 88.7 | 90.2 | 89.9 | 80.2 |
| Embodiment 18 | 78.8 | 37.8 | 88.2 | 87 | 86.9 | 88.5 | 89.6 | 79.6 |
| Embodiment 19 | 77.4 | 38.2 | 88 | 86.8 | 86.5 | 88.3 | 89.1 | 79.4 |
| Comparative | 92 | 65 | 76.3 | 74.5 | 79.4 | 81.2 | 81.5 | 68.4 |
| example 1 | | | | | | | | |
| Comparative | 98 | 69 | 74.6 | 72.1 | 78.5 | 79.8 | 79.1 | 66.4 |
| example 2 | | | | | | | | |
| Comparative | 89.7 | 75.6 | 72.1 | 70 | 74.3 | 76.4 | 77.4 | 64.1 |
| example 3 | | | | | | | | |
| Comparative | 90.2 | 78.6 | 72.3 | 70.2 | 72.1 | 73.6 | 73.5 | 61.5 |
| example 4 | | | | | | | | |
| Comparative | 88.5 | 90.2 | 66.5 | 64.1 | 68.3 | 70.2 | 70.8 | 60.4 |
| example 5 | | | | | | | | |
| Comparative | 86.7 | 89.5 | 67.2 | 65.2 | 64.2 | 66.8 | 68.3 | 58.6 |
| example 6 | | | | | | | | |
| Comparative | 100.8 | 80.4 | 64.2 | 62.1 | 69.4 | 71.4 | 71.2 | 60.8 |
| example 7 | | | | | | | | |
| Comparative | 110.7 | 80.3 | 65.2 | 63.2 | 68.4 | 70.9 | 70.8 | 61.2 |
| example 8 | | | | | | | | |
| Comparative | 105.4 | 76.7 | 69.5 | 67.5 | 70 | 72.1 | 71.3 | 62.8 |
| example 9 | | | | | | | | |
| Comparative | 109.3 | 84.6 | 65.3 | 63.1 | 65.3 | 68.1 | 69.4 | 60.1 |
| example 10 | | | | | | | | |
| Comparative | 100.6 | 88.6 | 62.9 | 60.2 | 62.5 | 65.2 | 62.1 | 51.3 |
| example 11 | | | | | | | | |
| Comparative | 105.3 | 90.2 | 67.2 | 65.2 | 64.9 | 67.3 | 68.4 | 59.7 |
| example 12 | | | | | | | | |
| Comparative | 99.3 | 83.9 | 63.2 | 61 | 67.9 | 70.2 | 70.5 | 61.4 |
| example 13 | | | | | | | | |
| Comparative | 96.2 | 88.7 | 65.2 | 63.2 | 61.2 | 63.5 | 64.8 | 56.8 |
| example 14 | | | | | | | | |
| Comparative | 97.8 | 83.2 | 63.2 | 61.2 | 60.9 | 62.9 | 66.7 | 57.9 |
| example 15 | | | | | | | | |

Based on the test results of Embodiments 1-19 and Comparative examples 1-15, it is shown that in the sodium-ion battery electrolyte, when a trace amount of sodium difluorophosphate is used as a sodium salt additive, and fluoroethylene carbonate, 1,3-propane sultone, and 1,3-propene sultone are used as film-forming additive, and when the mass percentage (a) of fluoroethylene carbonate, the mass percentage (b) of 1,3-propane sultone, the mass percentage (c) of 1,3-propene sultone, and the mass content (d) of sodium difluorophosphate in the sodium-ion battery electrolyte satisfy the following conditions: 0.3≤(a+b+c)×100/d≤7, 1≤a≤5, 0.5≤b≤2, 1≤c≤3, 100≤d≤1000, the obtained sodium-ion battery exhibits low impedance, excellent high-temperature cycle performance and high-temperature storage performance. This is presumably due to the trace amount of sodium difluorophosphate serving as a bridge in the passivation film formed by fluoroethylene carbonate, 1,3-propane sultone, and 1,3-propene sultone on the surface of the negative electrode, thereby regulating the formation quality of the passivation film. Specifically, it improves the density and stability of the passivation film on the surface of the negative electrode, so that the passivation film has an enhanced inhibitory effect on the interfacial reaction between the sodium-ion battery electrolyte and the negative electrode. This reduces gas generation caused by electrolyte decomposition under high-temperature conditions and improves the stability of storage performance and cycle performance of the sodium-ion battery at high-temperature. Meanwhile, the thickness of the passivation film formed by fluoroethylene carbonate, 1,3-propane sultone, and 1,3-propene sultone is reduced by the trace amount of sodium difluorophosphate, thereby reducing the resistance of the passivation film to ion transport, enhancing ionic conductivity, reducing interfacial impedance, and improving the rate capability of the sodium-ion battery.

Based on the test results of Embodiments 1-19, when the mass percentage (a) of fluoroethylene carbonate, the mass percentage (b) of 1,3-propane sultone, the mass percentage (c) of 1,3-propene sultone, the mass content (d) of sodium difluorophosphate in the sodium-ion battery electrolyte further satisfy the following conditions: 0.6≤(a+b+c)*100/d≤5.7, 2≤a≤4, 1≤b≤2, 1.5≤c≤2.5, 150≤d≤800, it is beneficial to further inhibit gas generation of the sodium-ion battery under high-temperature conditions, while improving the capacity recovery rate and cycle capacity retention rate of the sodium-ion battery during high-temperature storage.

Based on the test results of of Comparative examples 1-15, even if the mass percentage (a) of fluoroethylene carbonate, the mass percentage (b) of 1,3-propane sultone, the mass percentage (c) of 1,3-propene sultone, the mass content (d) of sodium difluorophosphate in the sodium-ion battery electrolyte further satisfy the condition of 0.3≤(a+b+c)*100/d≤7, the sodium-ion battery still fails to exhibit low impedance or excellent high-temperature cycle and storage performance if any of the values of a, b, c, or d fall outside their respective ranges. This indicates that the values of a, b, c, and d are strongly correlated with the performance of the passivation film formed on the surface of the negative electrode of the sodium-ion battery. In particular, when the content of sodium difluorophosphate in the sodium-ion battery electrolyte is too low or too high, the adverse effects on the battery system become pronounced. Similarly, even if the values of a, b, c, and d fall within their respective ranges, if the value of (a+b+c)*100/d does not meet the above predefined conditions, the improvement in battery performance remains insignificant.

(2) The test results of Embodiments 1 and 21-24 are shown in Table 3.

TABLE 3

| | | | | | Capacity | Capacity | | |
|---|---|---|---|---|---|---|---|---|
| | | Gas | Capacity | Capacity | retention | recovery | −20° C. low- | |
| | | generation | retention | retention | rate after | rate after | temperature | 25° C. 30 C |
| | | rate after | rate after | rate after | storage | storage | discharge | discharge |
| | Discharge | 200 cycles | 400 cycles | 400 cycles | at 60° C. | at 60° C. | capacity | capacity |
| | DCIR | at 45° C. | at 25° C. | at 45° C. | for 30 days | for 30 days | retention | retention |
| Group | (mΩ) | (%) | (%) | (%) | (%) | (%) | (%) | (%) |
| Embodiment 1 | 60 | 26 | 91.1 | 90 | 91.6 | 93.9 | 92.1 | 82.4 |
| Embodiment 21 | 63 | 29 | 90.9 | 89.9 | 91.4 | 93.5 | 90.4 | 80.8 |
| Embodiment 22 | 65 | 27 | 90.8 | 89.7 | 91.6 | 93.7 | 90.5 | 81.2 |
| Embodiment 23 | 68 | 29 | 91 | 90 | 91.5 | 93.5 | 91 | 81.8 |
| Embodiment 24 | 66 | 28 | 90.9 | 89.9 | 91.6 | 93.7 | 90.4 | 81.3 |

Based on the test results of Embodiments 1 and 21-24, when different type of primary sodium salt are used, and the mass percentage (a) of fluoroethylene carbonat, the mass percentage (b) of 1,3-propane sultone, the mass percentage (c) of 1,3-propene sultone, and the mass content (d) of sodium difluorophosphate in the sodium-ion battery electrolyte further meet the conditions: 0.3≤(a+b+c)*100/d≤7, 1≤a≤5, 0.5≤b≤2, 1≤c≤3, 100≤d≤1000, the combination also positively affects the improvement of high-temperature performance and reduction of impedance of the sodium-ion battery. This indicates that the type of primary sodium salt has a relatively limited influence on the performance of the sodium-ion battery system, and the critical influencing factor is sodium difluorophosphate.

(3) The test results of Embodiments 1 and 25-28 are shown in Table 4.

TABLE 4

| | | | | | Capacity | Capacity | | |
|---|---|---|---|---|---|---|---|---|
| | | Gas | Capacity | Capacity | retention | recovery | −20° C. low- | |
| | | generation | retention | retention | rate after | rate after | temperature | 25° C. 30 C |
| | | rate after | rate after | rate after | storage | storage | discharge | discharge |
| | Discharge | 200 cycles | 400 cycles | 400 cycles | at 60° C. | at 60° C. | capacity | capacity |
| | DCIR | at 45° C. | at 25° C. | at 45° C. | for 30 days | for 30 days | retention | retention |
| Group | (mΩ) | (%) | (%) | (%) | (%) | (%) | (%) | (%) |
| Embodiment 1 | 60 | 26 | 91.1 | 90 | 91.6 | 93.9 | 92.1 | 82.4 |
| Embodiment 25 | 62 | 28 | 90.9 | 89.8 | 91.5 | 93.6 | 90.5 | 81.3 |
| Embodiment 26 | 63 | 29 | 90.2 | 90.3 | 91.4 | 93.5 | 90.1 | 80.9 |
| Embodiment 27 | 68 | 26 | 91.5 | 90.3 | 91.2 | 91.3 | 91.2 | 80.4 |
| Embodiment 28 | 69 | 27 | 91.6 | 90.5 | 91 | 91.1 | 91.3 | 80.1 |

Based on the test results of Embodiments 1 and 25-28, in the battery system provided by the present disclosure, when different positive electrode active material are used, and the mass percentage (a) of fluoroethylene carbonate, the mass percentage (b) of 1,3-propane sultone, the mass percentage (c) of 1,3-propene sultone, and the mass content (d) of sodium difluorophosphate in the sodium-ion battery electrolyte meet the following conditions: 0.3≤(a+b+c)*100/d≤7, 1≤a≤, 0.5≤b≤2, 1≤c≤3, 100≤d≤100 the resulting sodium-ion battery also exhibits low impedance and excellent high-temperature performance, This indicates that the electrolyte system provided by the present disclosure is applicable to sodium-ion batteries employing different positive electrode active material.

TABLE 5

| | | | | | pore | pore | |
|---|---|---|---|---|---|---|---|
| | | | | | diameter | opening | |
| | | | | | of the | diameter | ratio of |
| | mass | mass | mass | mass | negative | of the | pore |
| | percentage of | percentage of | percentage of | content | electrode | negative | diameter |
| | fluoroethylene | 1,3-propane | 1,3-propene | of sodium | material | electrode | to pore |
| | carbonate a | sultone b | sultone c | difluorophosphate | layer | material | opening |
| Group | (%) | (%) | (%) | d (ppm) | (nm) | layer (nm) | diameter |
| Embodiment 29 | 2 | 1 | 2 | 300 | 2.6 | 0.5 | 5.2 |
| Embodiment 30 | 2 | 1 | 2 | 300 | 4.5 | 0.4 | 11.3 |
| Embodiment 31 | 2 | 1 | 2 | 300 | 4.2 | 0.5 | 8.4 |
| Embodiment 32 | 2 | 1 | 2 | 300 | 3.6 | 0.4 | 9.0 |
| Embodiment 33 | 2 | 1 | 2 | 300 | 2.9 | 0.4 | 7.3 |
| Embodiment 34 | 2.1 | 2 | 1.5 | 437 | 2.3 | 0.4 | 5.8 |
| Embodiment 35 | 3.3 | 1.6 | 2.3 | 613 | 1.9 | 0.5 | 3.8 |
| Embodiment 36 | 4.9 | 1.3 | 1.6 | 450 | 3.3 | 0.4 | 8.3 |
| Embodiment 37 | 2.6 | 1 | 2.2 | 265 | 2.7 | 0.5 | 5.4 |
| Embodiment 38 | 2 | 1 | 2 | 300 | 2.5 | 0.8 | 3.1 |
| Embodiment 39 | 2 | 1 | 2 | 300 | 3.1 | 0.2 | 15.5 |
| Embodiment 40 | 2 | 1 | 2 | 300 | 1.6 | 0.6 | 2.7 |
| Embodiment 41 | 2 | 1 | 2 | 300 | 1.6 | 0.1 | 16.0 |

### Embodiments 29-41

Embodiments 29-41 are used to illustrate the sodium-ion battery and the preparation method thereof disclosed in the present disclosure, including most of the steps in Embodiment 1, with the following differences.

The additives, sodium difluorophosphate and their respective contents shown in Embodiments 29-41 in Table 5 were used, and the pore diameter and pore opening diameter of the negative electrode material layer were as shown in Embodiments 29-41 in Table 5.

(4) The tests were carried out on Embodiments 29-41 by the method described above, and the obtained test results were recorded in Table 6.

TABLE 6

| | | | | | Capacity | Capacity | | |
|---|---|---|---|---|---|---|---|---|
| | | Gas | Capacity | Capacity | retention | recovery | −20° C. low- | |
| | | generation | retention | retention | rate after | rate after | temperature | 25° C. 30 C |
| | | rate after | rate after | rate after | storage | storage | discharge | discharge |
| | Discharge | 200 cycles | 400 cycles | 400 cycles | at 60° C. | at 60° C. | capacity | capacity |
| | DCIR | at 45° C. | at 25° C. | at 45° C. | for 30 days | for 30 days | retention | retention |
| Group | (mΩ) | (%) | (%) | (%) | (%) | (%) | (%) | (%) |
| Embodiment 29 | 64 | 30 | 90.7 | 89.5 | 91.1 | 93.4 | 91.3 | 81.9 |
| Embodiment 30 | 62 | 28 | 90.9 | 89.8 | 91.2 | 93.6 | 90.6 | 80.1 |
| Embodiment 31 | 60 | 27 | 91.1 | 89.9 | 91.4 | 93.8 | 91.7 | 82.2 |
| Embodiment 32 | 62 | 28 | 90.8 | 89.6 | 91.2 | 93.3 | 91.4 | 82.1 |
| Embodiment 33 | 63 | 29 | 90.6 | 89.2 | 91 | 93.1 | 91.2 | 81.7 |
| Embodiment 34 | 62 | 27 | 90.7 | 89.5 | 91 | 93.2 | 91.2 | 81.8 |
| Embodiment 35 | 61 | 26 | 90.9 | 89.7 | 91.2 | 93.4 | 91.4 | 82.0 |
| Embodiment 36 | 62 | 27 | 90.7 | 89.6 | 91 | 93.2 | 91.3 | 81.9 |
| Embodiment 37 | 63 | 28 | 90.5 | 89.4 | 90.7 | 93 | 91 | 81.6 |
| Embodiment 38 | 97.8 | 82.6 | 64.7 | 67.8 | 58.7 | 60.8 | 68.7 | 60.9 |
| Embodiment 39 | 99.4 | 86.4 | 61.2 | 69.7 | 61.2 | 63.4 | 69.4 | 64.7 |
| Embodiment 40 | 96.4 | 81.5 | 62.4 | 66.7 | 57.6 | 61.8 | 67.3 | 59.4 |
| Embodiment 41 | 102.3 | 88.9 | 60.1 | 63.5 | 56.3 | 60.2 | 65.8 | 57.4 |

From the test results of Embodiments 29-41, it was found that, in the sodium-ion battery system provided in the present disclosure, when sodium difluorophosphate, fluoroethylene carbonate, 1,3-propane sultone and 1,3-propene sultone were used as additives, and the ratio E of pore diameter to pore opening diameter of the negative electrode material layer was maintained within a range of 4-12, the high-temperature storage performance and high-temperature cycle performance of the sodium-ion battery could be improved while the battery impedance was reduced, meanwhile favorable low-temperature and rate performance could also be achieved. This indicates that regulating the ratio E of pore diameter to pore opening diameter of the negative electrode material layer facilitated regulation of the film-forming quality of sodium difluorophosphate, fluoroethylene carbonate, 1,3-propane sultone and 1,3-propene sultone in the pores of the negative electrode, thereby improving the sodium-ion conduction efficiency of the negative electrode while ensuring the high-temperature performance of the sodium-ion battery, and increasing the discharge capacity under low-temperature conditions as well as the charge/discharge performance at high rates.

The above are only preferred embodiments of the present disclosure and are not intended to limit the scope of the disclosure. Any modifications, equivalent substitutions, or improvements made within the spirit and principle of the present disclosure should be included within the scope of protection of the application.

What is claimed is:

1. A sodium-ion battery electrolyte, comprising: a sodium salt, a non-aqueous organic solvent and an additive, wherein the additive comprises fluoroethylene carbonate, 1,3-propane sultone and 1,3-propene sultone, the sodium salt comprises a primary sodium salt and sodium difluorophosphate;
the sodium-ion battery electrolyte satisfies the following conditions:
$$0.3 \leq ( a + b + c ) * 100 / d \leq 7 , and$$
$$1 \leq a \leq 5 , 0.5 \underline{<} b \leq 2 , 1 \leq c \leq 3 , 100 \leq d \leq 1 \; 000 ;$$
wherein:
a represents a mass percentage of fluoroethylene carbonate in the sodium-ion battery electrolyte, in %;
b represents a mass percentage of 1,3-propane sultone in the sodium-ion battery electrolyte, in %;
c represents a mass percentage of 1,3-propene sultone in the sodium-ion battery electrolyte, in %; and
d represents a mass content of sodium difluorophosphate in the sodium-ion battery electrolyte, in ppm.

2. The sodium-ion battery electrolyte of claim 1, wherein the sodium-ion battery electrolyte satisfies the following conditions:
$$0.6 \leq ( a + b + c ) * 100 / d \leq 5.7 .$$

3. The sodium-ion battery electrolyte of claim 1, wherein the mass percentage (a) of fluoroethylene carbonate in the sodium-ion battery electrolyte is 2%-4%.

4. The sodium-ion battery electrolyte of claim 1, wherein the mass percentage (b) of 1,3-propane sultone in the sodium-ion battery electrolyte is 1%-2%.

5. The sodium-ion battery electrolyte of claim 1, wherein the mass percentage (c) of 1,3-propene sultone in the sodium-ion battery electrolyte is 1.5%-2.5%.

6. The sodium-ion battery electrolyte of claim 1, wherein the mass content (d) of sodium difluorophosphate in the sodium-ion battery electrolyte is 150-800 ppm.

7. The sodium-ion battery electrolyte of claim 1, wherein the primary sodium salt comprises at least one selected from the group consisting of sodium perchlorate, sodium tetrafluoroborate, sodium hexafluorophosphate, sodium trifluoroacetate, sodium tetraphenylborate, sodium trifluoromethanesulfonate, sodium bis(fluorosulfonyl)imide and sodium bis(trifluoromethanesulfonyl)imide.

8. The sodium-ion battery electrolyte of claim 7, wherein a mass percentage of the primary sodium salt, based on a total mass of the sodium-ion battery electrolyte, is 8%-14%.

9. The sodium-ion battery electrolyte of claim 1, wherein the additive further comprises at least one selected from the group consisting of ethylene sulfate, 1,4-butane sultone, and difluoroethylene carbonate.

10. The sodium-ion battery electrolyte of claim 1, wherein a mass percentage of the additive, based on the total mass of the sodium-ion battery electrolyte of 100%, is 2.5%-10%.

11. The sodium-ion battery electrolyte of claim 1, wherein the non-aqueous organic solvent comprises at least one selected from the group consisting of carbonate esters, carboxylic esters, and ethers.

12. The sodium-ion battery electrolyte of claim 11, wherein the carbonate esters comprise cyclic or linear carbonate esters having 3-5 carbon atoms; the cyclic carbonate esters comprise at least one selected from the group consisting of ethylene carbonate, vinylene carbonate, vinyl ethylene carbonate, propylene carbonate, γ-butyrolactone, and butylene carbonate; the linear carbonate esters comprise at least one selected from the group consisting of dimethyl carbonate, ethyl methyl carbonate, diethyl carbonate and dipropyl carbonate.

13. The sodium-ion battery electrolyte of claim 11, wherein the carboxylic esters comprise carboxylic esters having 2-6 carbon atoms; the carboxylic esters comprise at least one selected from the group consisting of methyl acetate, ethyl acetate, propyl acetate, butyl acetate, and propyl propionate.

14. The sodium-ion battery electrolyte of claim 11, wherein the ethers comprise cyclic or linear ethers having 4-10 carbon atoms; the cyclic ethers comprise at least one selected from the group consisting of 1,3-dioxolane, 1,4-dioxane, tetrahydrofuran, 2-methyltetrahydrofuran and 2-(trifluoromethyl)tetrahydrofuran; the linear ethers comprise at least one selected from the group consisting of dimethoxymethane, 1,2-dimethoxyethane and diethylene glycol dimethyl ether.

15. The sodium-ion battery electrolyte of claim 1, wherein a mass percentage of the non-aqueous organic solvent, based on the total mass of the electrolyte of 100%, is 70%-92%.

16. A sodium-ion battery, comprising a positive electrode, a negative electrode, and the sodium-ion battery electrolyte of claim 1.

17. The sodium-ion battery of claim 16, wherein the negative electrode comprises a negative electrode material layer, a ratio E of pore diameter to pore opening diameter of the negative electrode material layer is 4-12.

18. The sodium-ion battery of claim 16, wherein the ratio E of pore diameter to pore opening diameter of the negative electrode material layer is 5-10.

19. The sodium-ion battery of claim 16, wherein the pore diameter of the negative electrode material layer is 0.5-5 nm, and/or, the pore opening diameter of the negative electrode material layer is 0.1-2 nm.
